(19) United States
(12) Patent Application Publication
(10) Pub. No.: US 2007/0031179 A1
(43) Pub. Date: Feb. 8, 2007

(54) Transfer plate with integral fastener for use in storage folder

(76) Inventor: Paul Whaley, Herculaneum, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/188,374

(22) Filed: Jul. 25, 2005

(51) Int. Cl. B42F 13/00

(52) U.S. Cl. 402/7

(57) ABSTRACT

A transfer plate (10) attaches to a leaf (L1) of a folder (F). Eyelets (16) for attaching the transfer plate to the folder are integrally formed with the plate. During assembly of the folder, the eyelets are inserted through holes formed in the leaf and outer ends (18) of the eyelets are then upset to secure the transfer plate to the folder. Other embodiments of the invention include a transfer plate having rivets (22), tabs (32, 34, 42, 44) or spurs (52) are integrally formed on the plate.

### CROSS REFERENCE TO RELATED APPLICATIONS

None

### STATEMENT REGARDING FEDERALLY SPONSORED RESEARCH OR DEVELOPMENT

N/A

### BACKGROUND OF THE INVENTION

This invention relates to folders used to store voluminous amounts of hole punched paper; and, more particularly, to a transfer plate attached to one leaf of the folder for use in reviewing papers stored in the folder.

Document folders or files are often used for storing substantial quantities of paper. Unlike a binder, these folders do not have a spine section intermediate the end leaves of the binder. Rather, the folder comprises a thick, single sheet of file stock folded in the middle. A compression plate and associated flexible, hollow, tubular member are used to secure pages of documents in the folder. A transfer plate and associated rigid member are used when someone wants to view the documents.

The transfer plate is secured to one leaf of the folder, the compression plate is not. Heretofore, the transfer plate has been affixed to the folder using eyelets. The plate has holes formed at each end and corresponding holes are punched into the folder leaf. Eyelets are then inserted through the leaf and holes in the transfer plate and deformed to attach the transfer plate securely to the folder. This folder construction requires forming a transfer plate with holes at each end, as well as two eyelets for each plate. During manufacture, spaced holes have to be punched into the folder, the transfer plate properly located so the holes in the plate align with the holes in the paper, the respective eyelets inserted through the holes, and the inner end of each eyelet being deformed about the transfer plate to secure the plate to the folder.

While it will be appreciated that the cost of the transfer plate and the separate eyelets and the manufacturing steps are neither cost nor time consuming, they represent a cost nevertheless. By modifying the design of the transfer plate, as described herein, the eyelets can be eliminated and the number of manufacturing steps reduced. Given the volume of folders produced, this represents a substantial cost savings. It is known, for example, to attach a transfer type plate to a folder using heat bonding such as taught in U.S. Pat. No. 4,084,911, or using an adhesive material such as taught in U.S. Pat. No. 4,632,586. However, either of these approaches necessitate the use of special materials or manufacturing processes which ultimately do not result in an appreciable cost savings, if any.

### BRIEF SUMMARY OF THE INVENTION

The present invention is directed to a transfer plate for attachment to a folder in which the means for attaching the transfer plate to the folder is integral with the plate. In one embodiment of the invention, eyelets are integrally formed with the plate. In a second embodiment, rivets are integrally formed on the plate. In a third embodiment, tabs are formed on the plate; while in another embodiment, spurs are formed with the plate.

Attachment of some embodiments of the transfer plate require holes to be formed in the folder leaf to which the plate is attached, while other embodiments of the transfer plate make their own holes in the leaf as part of the attachment process. In either instance, the transfer plate of the present invention requires fewer parts and fewer manufacturing steps than prior art transfer plates, while still enabling the plate to be securely affixed to the folder leaf and not becoming disengaged during subsequent use of the folder.

Other objects and features will be in part apparent and in part pointed out hereinafter.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a plan view of a Prior Art folder, and FIG. 2 is an elevation view of the folder;

FIGS. 3A and 3B are respective plan and elevation views of a first embodiment of a transfer plate of the present invention with an integral fastened for attaching the plate to a folder leaf;

FIGS. 4A and 4B are similar views for a second embodiment of the plate;

FIGS. 5A and 5B are similar views for another embodiment of the plate;

FIGS. 6A and 6B are similar views for another embodiment of the plate;

FIGS. 7A and 7B are similar views for another embodiment of the plate;

FIGS. 8 and 9 are plan views of other embodiments of the plate.

Corresponding reference characters indicate corresponding parts throughout the several views of the drawings.

### DETAILED DESCRIPTION OF INVENTION

The following detailed description illustrates the invention by way of example and not by way of limitation. This description will clearly enable one skilled in the art to make and use the invention, and describes several embodiments, adaptations, variations, alternatives and uses of the invention, including what I presently believe is the best mode of carrying out the invention. As various changes could be made in the above constructions without departing from the scope of the invention, it is intended that all matter contained in the above description or shown in the accompanying drawings shall be interpreted as illustrative and not in a limiting sense.

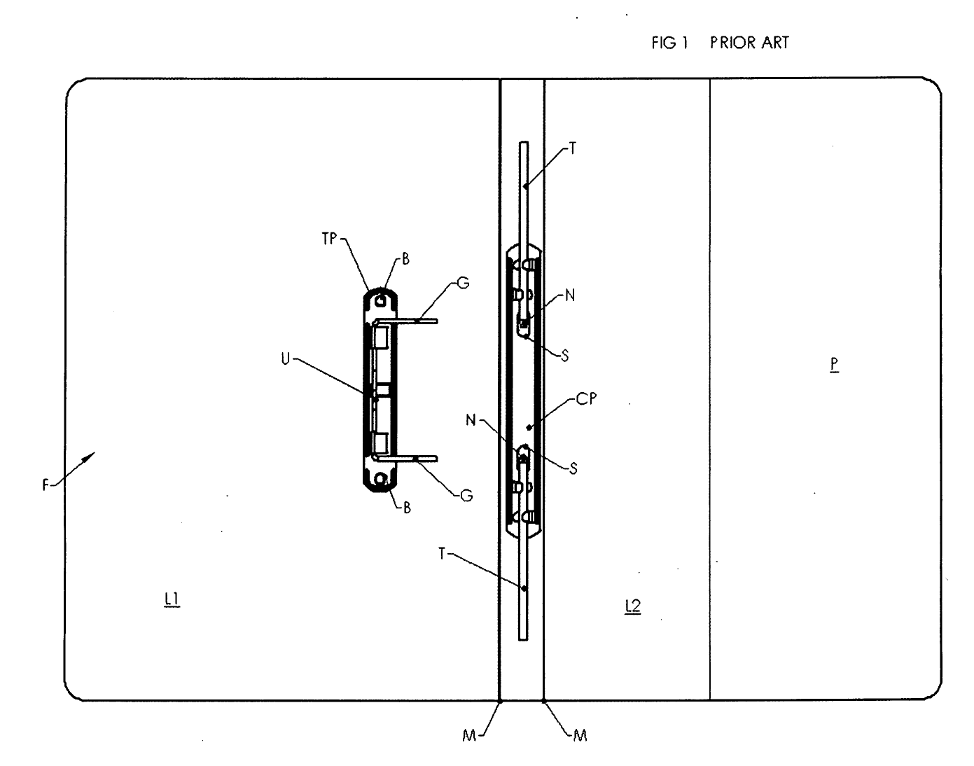

Referring to the drawings, a Prior Art folder is illustrated in FIGS. 1 and 2. Here, a folder F comprises a single sheet of heavy paper folded as indicated at M to form respective end leaves L1, L2. Some folders are further formed to have a pocket P formed on the inside of one of the leaves.

A transfer plate TP is attached to the inside of one of the leaves L1. The plate includes an elongate, generally rectangular plate with holes formed at each end of the plate. Corresponding holes are also formed in the leaf to which the plate is attached. Eyelets E are now inserted through the respective holes in the leaf and plate and are used to secure the plate to the inside of the leaf. Use of an eyelet for this purpose is well-known in the art. A U-shaped member U is rotatably secured to plate TP so as to be movable from a horizontal position shown in FIG. 1, to a vertical position shown in FIG. 2. The length of the member is such that the distance between legs G formed at the respective ends of member U corresponds to the distance between holes punched in sheets of paper stored in the folder.

The folder further includes a compression plate CP which is also an elongate, generally rectangular shaped plate. This plate has a pair of spaced slots S formed intermediate the length thereof. A flexible, hollow tubular member T is inserted through openings N formed in sheet S with respective ends N of the member fitting through one of the slots S in compression plate CP. The spacing of the openings again corresponds to the distance between holes punched in sheets of paper stored in the folder. The tubular member is secured to the compression plate so, when not in use, the respective ends N are locked onto the plate as shown in FIG. 1. When sheets of paper are added to the folder, the ends of tubular member M are detached from compression plate CP and the plate is removed. Documents D are now stored in the folder by inserting the respective ends of member T through the holes in the paper. Once all the documents are in place, compression plate P is lowered onto the top sheet of documents and the ends N of member T are again locked onto the plate.

If someone wants to look at a document stored in the folder, member U is raised to its vertical position, the ends N of tubular member T are unlocked from the compression plate, and the outer ends of the member are slid over the upper end of the legs G of member U as shown in FIG. 2. The folder is now open and the user can search through the documents by merely transferring sheets of paper from the one side of the folder to the other. When finished, the above described process is reversed to again position and lock compression plate CP over the outermost document.

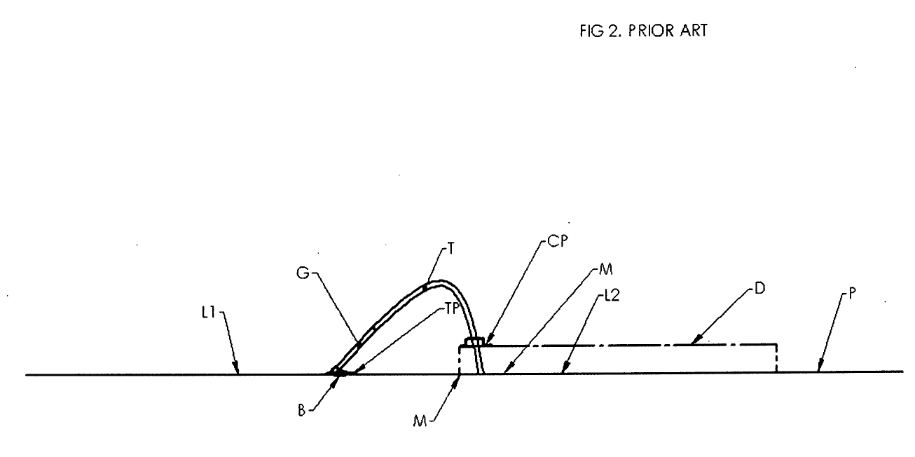

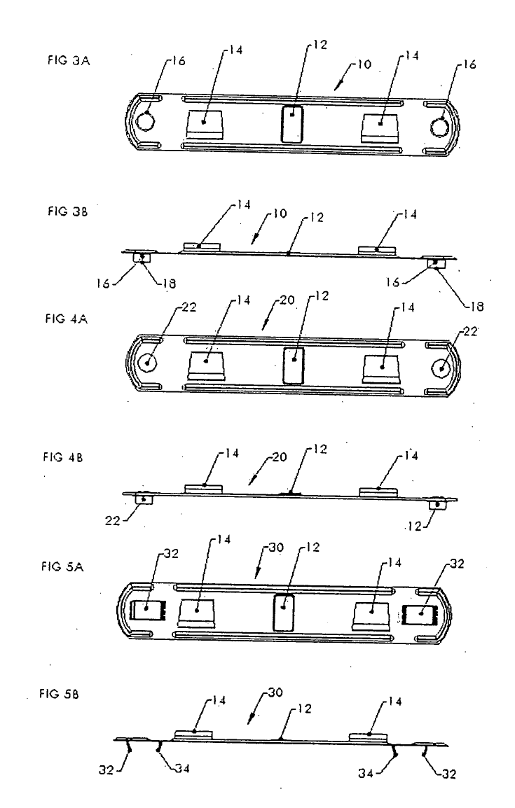

Referring to FIGS. 3A and 3B a first embodiment of a transfer plate of the present invention is indicated generally 10. The plate is of an elongate stamped part of a generally rectangular shape with rounded ends. The plate has a central raised portion 12 and bent over ears 14, formed on opposite sides of portion 12. These elements retain U-shaped member U and provide a base for the member to be rotated from its flat position shown in FIG. 1 to its upright position of FIG. 2. When plate 10 is formed, eyelets 16 are integrally formed with the plate and, as shown in FIG. 3B depend beneath the plate. During assembly of folder F, the eyelets are inserted through holes formed in the leaf and the outer ends 18 of the eyelets are then upset to secure the transfer plate to the folder. Accordingly, the eyelets, which comprise attaching means for securing the transfer plate to the leaf of the folder is integral with the transfer plate, the attaching means and plate forming a single piece.

Use of transfer plate 10 with its integral means of attachment provides a number of advantages. First, fewer parts are now required since the separate eyelets E previously required are no longer needed. Second, the manufacturing process is simplified since it is no longer necessary to position and hold the transfer plate in place while the eyelets are installed and deformed to secure the plate to the folder. The overall result is reduced parts cost and decreased assembly time. And, the transfer plate is at least as well secured to the folder leaf as with the prior art folder construction.

FIGS. 4A through 9 show alternate embodiments of the transfer plate with an integral fastener. In FIGS. 4A and 4B, a transfer plate 20 has rivets 22 integrally formed with the plate and depending beneath the plate.

In FIGS. 5A and 5B, a transfer plate 30 has tabs 32 or 34 integrally formed with the plate and depending beneath the plate. As shown in FIG. 5B, the solid line tabs 32 extend inwardly toward the center of plate 30, while the dashed line tabs 34 extend outwardly. The tabs preferably have a pointed outer end and when the tabs are bent over the outer face of a folder leaf the ends are further bent so they “bite” into the outer face of the leaf.

In FIGS. 6A and 6B, a transfer plate 40 has tabs 42 or 44 integrally formed with the plate and depending beneath the plate. Now, the tabs are formed intermediate the central raised portion 12 of plate 40 and the ears 14 formed adjacent the respective outer ends of the plate. In FIG. 6B, solid line tabs 42 extend inwardly toward the center of plate 40, while the dashed line tabs 44 extend outwardly. Again, the tabs preferably have a pointed outer end and when the tabs are bent over the outer face of a folder leaf the ends are further bent so they “bite” into the outer face of the leaf.

Although not shown in the drawings, those skilled in the art will understand that rather than being formed completely within the body of transfer plate 30 or 40, the tabs could be formed so as to extend from the outer edge of the transfer plate into the body of the plate.

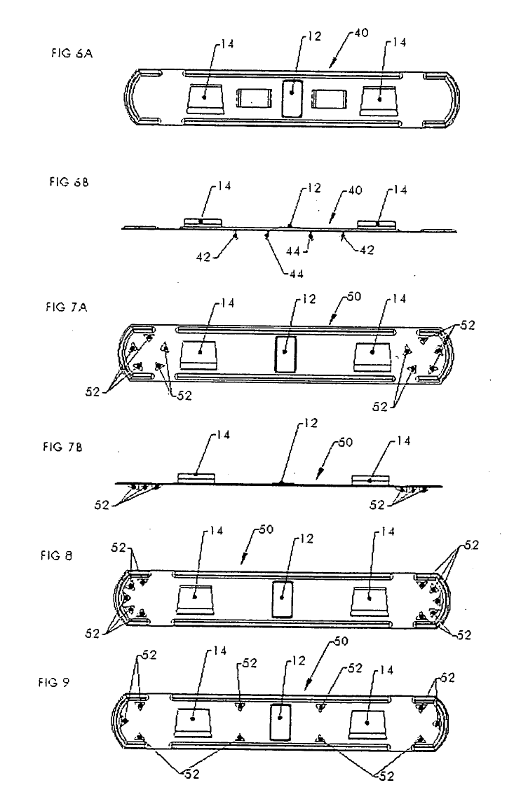

In FIGS. 7A and 7B, a transfer plate 50 has a plurality of spurs 52 integrally formed with the plate and depending beneath the plate. In FIG. 7A, the spurs are shown to be formed in a generally circular pattern between the respective ends of the transfer plate and the ears 14 formed adjacent the respective ends of the plate. The spurs all have a pointed outer end so they can be pushed through leaf L1 to which the transfer plate is attached to secure plate 50 in place.

FIGS. 8 and 9 illustrate alternative embodiments of a transfer plate having spurs. In FIG. 8, a transfer plate 50′ has spurs 52 arranged in a generally semi-circular pattern around each end of the plate; while in FIG. 9, a transfer plate 50″ has spurs 52 spaced around each end and the sides of the transfer plate.

Again, although not shown in the drawings, those skilled in the art will understand that rather than being formed completely within the body of the transfer plate 50-50″, the spurs 52 could be formed so as to extend from the outer edge of the transfer plate into the body of the plate.

In view of the above, it will be seen that the several objects and advantages of the present invention have been achieved and other advantageous results have been obtained.

Having thus described the invention, what is claimed and desired to be secured by Letters Patent is:

1. A transfer plate for attachment to a leaf of a folder used to store hole punched sheets of paper or the like comprising:
a plate; and,
attaching means for securing the plate to the leaf, said attaching means being integral with the plate.

2. The transfer means of claim 1 in which the attaching means is integrally formed with the plate, the plate and attaching means comprising a single piece.

3. The transfer plate of claim 1 in which said attaching means extend outwardly from the plate.

4. The transfer plate of claim 3 in which said attaching means includes a pair of eyelets one of which is formed adjacent each end of the plate.

5. The transfer plate of claim 3 in which said attaching means includes a pair of rivets one of which is formed adjacent each end of the plate.

6. The transfer plate of claim 3 in which said attaching means includes a pair of tabs.

7. The transfer plate of claim 6 in which said pair of tabs includes a tab formed adjacent each end of the plate.

8. The transfer plate of claim 6 in which said pair of tabs are formed intermediate the ends of the plate.

9. The transfer plate of claim 6 in which each tab has a pointed outer end so when the tabs are bent over an outer face of the folder leaf the ends are bent so they bite into the outer face of the leaf to secure the transfer plate to the leaf.

10. The transfer plate of claim 3 in which said attaching means includes a plurality of spurs.

11. The transfer plate of claim 10 in which the spurs have a pointed outer end which is pushed through the leaf to which the plate is attached to secure the plate in place.

12. The transfer plate of claim 11 including a set of spurs adjacent each end of the plate.

13. The transfer plate of claim 12 in which each set of spurs is formed in a generally circular pattern at its respective end of the plate.

14. The transfer plate of claim 12 in which each set of spurs is formed in a generally semi-circular pattern around each end of the plate.

15. The transfer plate of claim 11 in which the spurs are spaced around each end and the sides of the transfer plate.
